(19) United States
(12) Patent Application Publication
(10) Pub. No.: US 2025/0175278 A1
(43) Pub. Date: May 29, 2025

(54) SECURING KEYBOARD INPUT

(71) Applicant: Microsoft Technology Licensing, LLC, Redmond, WA (US)

(72) Inventors: Shoham DEKEL, Tel Aviv (IL); Assaf Bar Ness, Rehovot (IL); Yoel Yeheskel Einhoren, Petah Tiqwa (IL); Netnael Hadad, Lod (IL)

(21) Appl. No.: 18/519,721

(22) Filed: Nov. 27, 2023

(51) Int. Cl. H04K 1/02

(52) U.S. Cl. CPC H04K 1/02

(57) ABSTRACT

The technology described herein protects against key logging at a keyboard input processor. The technology described herein includes a keyboard with a plurality of keys, a key matrix, a crossbar, and a KIP. The crossbar scrambles a key signal generated by the key matrix according to a scramble instruction known to the computer receiving the keyboard input. The result produced by the crossbar may be described as a scrambled key signal. The scrambled key signal may correspond to a different key signal produced by the key matrix. A different scramble instruction may be provided for each keystroke. The scramble instruction may be used by the computing device receiving a scrambled keystroke to unscramble it.

### BACKGROUND

Schemes to fraudulently acquire another person's credential and password information have become common. Some schemes include user action, in which a user inputs information to an application through a human-computer interface, such as a keyboard. An operating system can be compromised using interception tactics, such as keystroke logging. Keyloggers can be difficult to detect and remove from an operating system. In view of the foregoing, there is a need for techniques that facilitate secure communication between a keyboard and an input destination.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein protects against key logging at a keyboard input processor. The technology described herein may work with an integrated keyboard or an external keyboard. Many computer keyboards include a keyboard input processor (“KIP”), which may be a microcontroller that includes a microprocessor, software, and memory on a single computer chip. The KIP scans the keyboard matrix to detect keystrokes and then reports the key presses and key releases to a computer. Unfortunately, it is possible for the computer code (e.g., firmware) on the KIP to be compromised to act as a key logger. The technology described herein prevents the KIP from knowing what key is being pressed by scrambling the key signal before it is received by the KIP. This causes the wrong keys to be logged, should logging occur.

The key-signal scrambling is done by a crossbar installed between a keyboard's key matrix and the keyboard input processor. The crossbar may be controlled by a security component running on the computing device receiving input from the keyboard. The security component may be a secure processor or take another form. The security component provides a scrambling instruction, which causes the crossbar to scramble the key signal in a predictable way if the scrambling instruction is known. Using the scramble instruction, the security component is able to unscramble the scrambled keystrokes provided by the KIP.

The technology described herein includes a keyboard with a plurality of keys, a key matrix, a crossbar, and a KIP. The crossbar scrambles a key signal generated by the key matrix according to a scramble instruction known to the computer receiving the keyboard input. The result produced by the crossbar may be described as a scrambled key signal. The scrambled key signal may correspond to a different key signal produced by the key matrix. For example, the crossbar may receive a key signal for the “a” key and scramble it to a scrambled key signal for the “f” key. The KIP then receives the “f” key signal when the “a” key is pushed. The KIP would then generate a scan code for “f.” The crossbar prevents the KIP from knowing what key is actually pushed. Any logging occurring at a compromised KIP would log the wrong key.

The scramble instruction may be provided by a secure processor or other security component on the computing device. In most cases, this disclosure will describe aspects using a secure processor. A different scramble instruction may be provided for each keystroke. The scramble instruction may be for the crossbar to open and close a series of switches to cause a first crossbar configuration. The result (e.g., “e” signal instead of “f” signal) of the first crossbar configuration is known by the secure processor, such that the resulting scan code can be reverse engineered (e.g. “f” to “e”) to reveal the actual key pushed. The secure processor may have a table that maps the result of each keystroke in a given crossbar configuration to a key push. For example, in a first crossbar configuration an “a” signal may be converted to an “h” signal, while in a second configuration the “a” signal is converted to a “b” signal. Thus, using the table, a scan code for “h” or “b” could be converted back to “a” given the configuration which may be ascertained from the scramble instruction provided.

In an embodiment, a hardware security module (“HSM”) may be installed at the keyboard and used to control the crossbar. A HSM is a physical computing device that safeguards and manages secrets and performs cryptographic functions. The use of an HSM may have particular benefit in an external keyboard implementation. When HSM is used, the computing device receiving keyboard input may provide a seed to the HSM instead of a scramble instruction. The HSM then uses the seed to generate a scramble instruction that is provided to the crossbar. The scramble instruction would be generated through a deterministic algorithm that generates a predictable series of results given the seed. The algorithm may be a pseudorandom number generator. The computing device may use the same algorithm and seed to generate scramble instructions that are used to unscramble a scrambled keystroke provided to the computing device by the KIP.

The technology described herein may enable a keyboard to communicate in a standard mode and in a secure mode. In the standard mode, the keyboard communicates like currently available keyboards. Essentially, the crossbar simply passes the key signal without scrambling. The standard mode allows the keyboard to communicate with components that are not capable of receiving secure communications. In the case of an external keyboard, some computing devices may not include a secure processor or other security component that is capable of interacting with a crossbar. In this case, the standard mode allows the external keyboard to be used with different devices. With either integrated or external keyboard, some computing devices may operate in secure mode via a secure processor or a standard mode, which does not use the secure processor. The standard mode of the keyboard may be used when the computing device is also in standard mode.

### BRIEF DESCRIPTION OF THE DRAWINGS

The technology described herein is illustrated by way of example and not limitation in the accompanying figures in which like reference numerals indicate similar elements and in which:

FIG. 1 is a diagram of a computing system suitable for implementations of the technology described herein;

FIG. 2 is a block diagram of an example operating environment with an integrated keyboard suitable for implementations of the technology described herein;

FIG. 3 is a block diagram of an example operating environment with an external keyboard suitable for implementations of the technology described herein;

FIG. 4 is a flow diagram showing a method of securing keyboard input, in accordance with an aspect of the technology described herein;

FIG. 5 is a flow diagram showing a method of securing keyboard input, in accordance with an aspect of the technology described herein;

FIG. 6 is a flow diagram showing a method of securing keyboard input, in accordance with an aspect of the technology described herein; and

FIG. 7 is a block diagram showing a computing device suitable for implementations of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein protects against key logging at a keyboard input processor. The technology described herein may work with an integrated keyboard or an external keyboard. Many computer keyboards include a keyboard input processor (“KIP”), which may be a microcontroller that includes a microprocessor, software, and memory on a single computer chip. The KIP scans the keyboard matrix to detect keystrokes and then reports the key presses and key releases to a computer. Unfortunately, it is possible for the computer code (e.g., firmware) on the KIP to be compromised to act as a key logger. The technology described herein prevents the KIP from knowing what key is being pressed by scrambling the key signal before it is received by the KIP. This causes the wrong keys to be logged, should logging occur.

The key-signal scrambling is done by a crossbar installed between a keyboard's key matrix and the keyboard input processor. The crossbar may be controlled by a security component running on the computing device receiving input from the keyboard. The security component may be a secure processor or take another form. The security component provides a scrambling instruction, which causes the crossbar to scramble the key signal in a predictable way if the scrambling instruction is known. Using the scramble instruction, the security component is able to unscramble the scrambled keystrokes provided by the KIP.

Conventionally, a keyboard may include a plurality of keys, a key matrix, and a KIP. When a user presses a key, the key contacts the key matrix. The contact causes the key matrix to generate a unique key signal that is received by the KIP. Each key is associated with a different key signal. The KIP then generate scrambled keystroke based on the key signal. The scrambled keystroke may take the form of a scan code. The scan code may be a series of bytes that identify the key pressed according to a data schema understood by the component receiving the scan code. The scan code is communicated through a wired or wireless connection to the computing device. A function on the computing device may translate the scan code into a corresponding text code. The text code is then communicated to the application or container in control focus through an input application program interface (API).

The technology described herein includes a keyboard with a plurality of keys, a key matrix, a crossbar, and a KIP. The crossbar scrambles a key signal generated by the key matrix according to a scramble instruction known to the computer receiving the keyboard input. The result produced by the crossbar may be described as a scrambled key signal. The scrambled key signal may correspond to a different key signal produced by the key matrix. For example, the crossbar may receive a key signal for the “a” key and scramble it to a scrambled key signal for the “f” key. The KIP then receives the “f” key signal when the “a” key is pushed. The KIP would then generate a scan code for “f.” The crossbar prevents the KIP from knowing what key is actually pushed. Any logging occurring at a compromised KIP would log the wrong key.

The scramble instruction may be provided by a secure processor or other security component on the computing device. In most cases, this disclosure will describe aspects using a secure processor. A different scramble instruction may be provided for each keystroke. The scramble instruction may be for the crossbar to open and close a series of switches to cause a first crossbar configuration. The result (e.g., “e” signal instead of “f” signal) of the first crossbar configuration is known by the secure processor, such that the resulting scan code can be reverse engineered (e.g. “f” to “e”) to reveal the actual key pushed. The secure processor may have a table that maps the result of each keystroke in a given crossbar configuration to a key push. For example, in a first crossbar configuration an “a” signal may be converted to an “h” signal, while in a second configuration the “a” signal is converted to a “b” signal. Thus, using the table, a scan code for “h” or “b” could be converted back to “a” given the configuration which may be ascertained from the scramble instruction provided.

In an embodiment, a hardware security module (“HSM”) may be installed at the keyboard and used to control the crossbar. A HSM is a physical computing device that safeguards and manages secrets and performs cryptographic functions. The use of an HSM may have particular benefit in an external keyboard implementation. When HSM is used, the computing device receiving keyboard input may provide a seed to the HSM instead of a scramble instruction. The HSM then uses the seed to generate a scramble instruction that is provided to the crossbar. The scramble instruction would be generated through a deterministic algorithm that generates a predictable series of results given the seed. The algorithm may be a pseudorandom number generator. The computing device may use the same algorithm and seed to generate scramble instructions that are used to unscramble a scrambled keystroke provided to the computing device by the KIP.

The technology described herein may enable a keyboard to communicate in a standard mode and in a secure mode. In the standard mode, the keyboard communicates like currently available keyboards. Essentially, the crossbar simply passes the key signal without scrambling. The standard mode allows the keyboard to communicate with components that are not capable of receiving secure communications. In the case of an external keyboard, some computing devices may not include a secure processor or other security component that is capable of interacting with a crossbar. In this case, the standard mode allows the external keyboard to be used with different devices. With either integrated or external keyboard, some computing devices may operate in secure mode via a secure processor or a standard mode, which does not use the secure processor. The standard mode of the keyboard may be used when the computing device is also in standard mode.

The technology described herein provides several security enhancements. The security enhancements may include scrambling of keystrokes, with unscrambling occurring at a secure processor. The scrambling may be performed by a crossbar operating between a keyboard and a keyboard input processor. The crossbar may perform the scramble using a scrambled instruction received from the secure processor. The scramble instruction may include a seed or other guidance that allows the crossbar to perform a deterministic scramble operation that may be undone by a device in possession of the seed or other guidance. Each keystroke may be scrambled using a different seed. In this way, the secure processor provides a sequence of seeds to the crossbar and the crossbar uses the sequence of seeds in the order received to scramble keystrokes. The scrambled keystrokes are then communicated to the keyboard input processor, which communicates the scrambled keystroke to the secure processor.

The secured processor or other security component may then encrypt the unscrambled keystroke for communication to an input destination, such as a virtual environment. The input destination may decrypt the unscrambled keystroke. The scrambling and encryption of keystrokes increases the difficulty of extracting useful information from the keystrokes if the keystroke is intercepted between the keyboard and input destination.

The security enhancements may also include providing an attestation that the keyboard is secure to the input destination (e.g., virtual environment). The input destination may be defined as the application or container in control focus. A container may host a virtual environment, such as provided by a virtual machine operating in a data center. Control focus may be a state characteristic of an application. An operating system (OS) may determine control focus in response to user inputs. For example, a user clicking on or otherwise selecting a graphical user interface feature associated with an application may bring the application into control focus. Subsequent keyboard inputs may be routed to the application that is in control focus. Typically, a keyboard is not aware of which application or object is in control focus. In other words, the keyboard typically communicates input to an unknown input destination.

Existing security technology assumes the keyboard input processor is trustworthy, which is not always the case. The keyboard input processor's firmware may be compromised and used to log keystrokes. The technology described herein reduces the effectiveness of keylogging at the KIP, should it occur.

The technologies herein are described using key terms wherein definitions are provided. However, the definitions of key terms are not intended to limit the scope of the technologies described herein.

An operating system is a program (or set of programs) that manages the resources on a computing device. Typically, the operating system offers these resources to a user through programs called applications. Applications perform tasks such as word-processing, gaming, internet activities, etc. The operating system is an intermediary between the applications and the computer hardware. Operating systems have libraries of programs that applications can use to create standardized user interaction.

A keyboard is a peripheral input device that uses an arrangement of buttons or keys to act as mechanical levers or electronic switches that receive input. The buttons or keys may each correspond to a value (e.g., number or letter).

An encrypter is an algorithm, software application, or device that encrypts data, such as keystrokes. Encryption is the process of converting or scrambling data and information (plain text) into an unreadable, encoded version (cipher text) that can only be read with a decryption key. Encryption may use a cryptographic key. A cryptographic key may be a set of mathematical values. Data can be encrypted “at rest,” when it is stored, or “in transit,” while it is being transmitted somewhere else.

Decryption is the reverse process of encryption. It is a procedure of transforming cipher text into plain text. Cryptography uses a decryption technique at the receiver side to acquire the original message from cipher text. Decryption operates by using the opposite conversion algorithm used to encrypt the data. The same key is used to return the encrypted data to its original form. In decryption, the system extracts and transforms the encrypted data to text and images that are comprehensible to a user.

Containerization is a process of operating system-level virtualization or application-level virtualization over multiple computer resources so that software applications can run in isolated user spaces called containers. A single container might be used to run anything from a small microservice or software process to a larger application. Inside a container are all the necessary executables, binary code, libraries, and configuration files to run the service or process.

As crossbar has multiple input and output lines that form a crossed pattern of interconnecting lines between which a connection may be established by closing a switch located at each intersection, the elements of the matrix.

Having briefly described an overview of aspects of the technology described herein, an operating environment in which aspects of the technology described herein may be implemented is described below in order to provide a general context for various aspects.

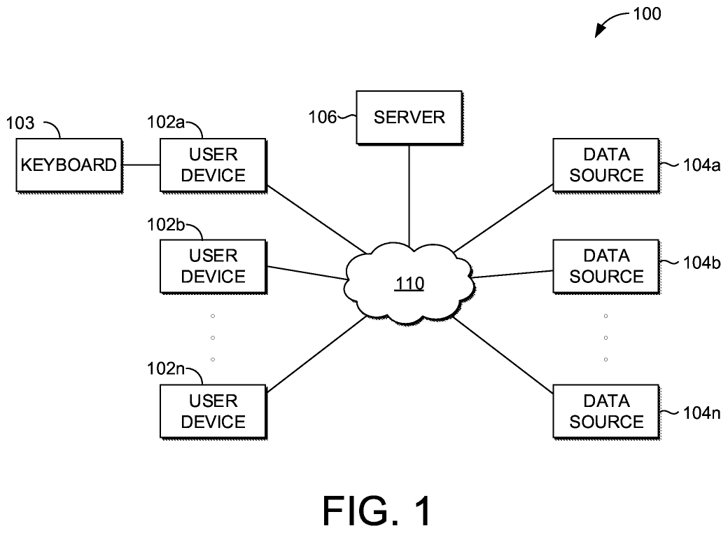

Turning now to FIG. 1, a block diagram is provided showing an example operating environment 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

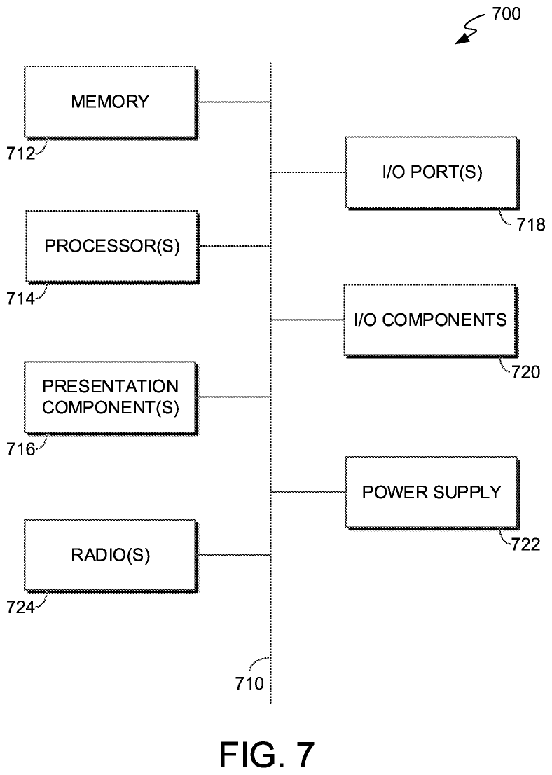

Among other components not shown, example operating environment 100 includes a number of user computing devices, such as user devices 102b through 102n; a number of data sources, such as data sources 104a and 104b through 104n; server 106; keyboard 103; and network 110. Each of the components shown in FIG. 1 is implemented via any type of computing device, such as computing device 700 illustrated in FIG. 7, for example. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

It should be understood that any number of user devices, servers, and data sources can be employed within operating environment 100 within the scope of the present disclosure. Each may comprise a single device or multiple devices cooperating in a distributed environment, such as the distributed computing device 700 in FIG. 7. For instance, server 106 is provided via multiple devices arranged in a distributed environment that collectively provides the functionality described herein. Additionally, other components not shown may also be included within the distributed environment.

User devices 102b through 102n can be client user devices on the client-side of operating environment 100, while server 106 can be on the server-side of operating environment 100. Server 106 can comprise server-side software designed to work in conjunction with client-side software on user devices 102b through 102n so as to implement any combination of the features and functionalities discussed in the present disclosure. In one aspect, the server hosts a virtual machine that interacts with a container provided by a secure processor on a user device. In aspects, the keystroke scrambling enables the secure processor to provide an attestation to the server 106 that the keyboard input is secure from the keyboard to the server 106. This division of operating environment 100 is provided to illustrate one example of a suitable environment, and there is no requirement for each implementation that any combination of server 106 and user devices 102b through 102n remain as separate entities.

In some embodiments, user devices 102b through 102n comprise any type of computing device capable of use by a user. For example, in one embodiment, user devices 102b through 102n are the type of computing device 700 described in relation to FIG. 7. By way of example and not limitation, a user device is embodied as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an MP3 player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

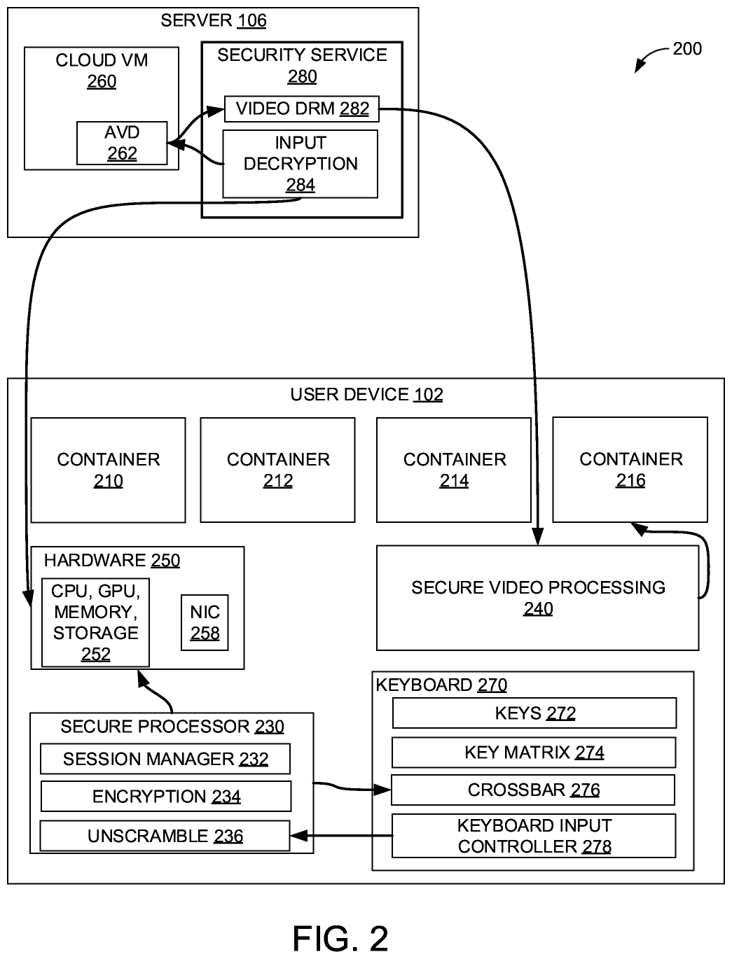

In some embodiments, data sources 104a and 104b through 104n comprise data sources and/or data systems, which are configured to make data available to any of the various constituents of operating environment 100 or system 200 described in connection to FIG. 2. In aspects, the technology described herein may seek permission from a user to access a data source to complete a task more accurately. Certain data sources 104a and 104b through 104n are discrete from user devices 102b through 102n and server 106 or are incorporated and/or integrated into at least one of those components. In one embodiment, one or more of data sources 104a and 104b through 104n comprise one or more sensors, which are integrated into or associated with one or more of the user device(s) 102b through 102n or server 106. For example, the data sources could include a web camera used to interact with a virtual environment.

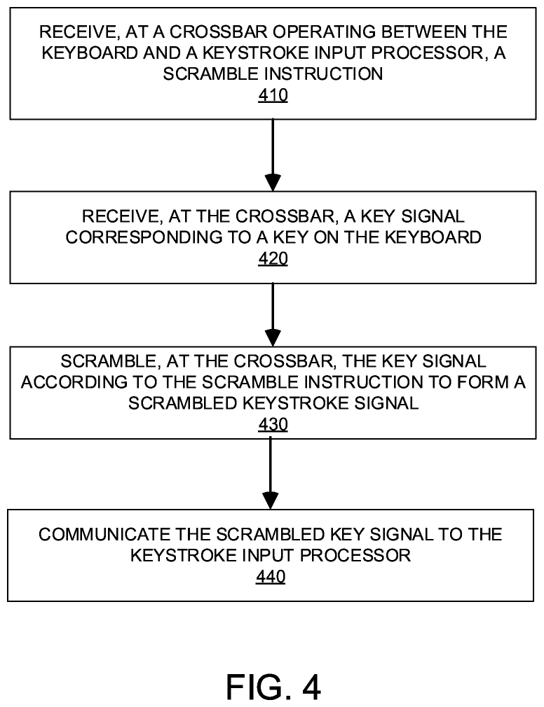

Operating environment 100 can be utilized to implement one or more of the components of system 200, as described in FIG. 2, including components for accessing and collecting additional information from various sources; receiving user preferences and/or permissions for using the information through a privacy conversation interface, for generating a task response using the additional information; and presenting task responses. Operating environment 100 can also be utilized for implementing aspects of methods 400, 500, and 600 in FIGS. 4, 5, and 6, respectively.

In some examples, the keyboard 103 is also a computing device. The keyboard 103 includes a processor (e.g., KIP), memory, and software components that may be able to form a secure connection and encrypt keystrokes before transmittal. The keyboard 103 may be able to communicate with containers and applications in order to form a secure connection. The formation of a secure connection may include the exchange of messages and security tokens.

Individual keys on the keyboard 103 may be depressed to provide input, for example, in the form of electrical signals to the KIP. The terms “input” and “output” are used in this description in reference to example keyboard actions. When used in connection with a keyboard key, the term “input” will generally refer to the key signal that is generated by the keyboard matrix in response to operation of the key. “Output” will generally refer to the data provided to the user device. In standard mode, the output may be an unscrambled scan code. In secure mode, the output may be a scrambled scan code.

Conventionally, a keyboard may include a plurality of keys, a key matrix, and a KIP. When a user presses a key, the key contacts the key matrix. This cause the key matrix to generate a unique key signal that is received by the KIP. The KIP then generate a scan code based on the key signal. The scan code is communicated through a wired or wireless connection to the computing device. The scan code may take the form of a series of bytes. A function on the computing device may translate the scan code into a corresponding text code. The text code is then communicated to the application or container in control focus through an input application program interface (API).

The technology described herein includes a keyboard with a plurality of keys, a key matrix, a crossbar, and a KIP. The crossbar scrambles a key signal generated by the key matrix according to a scramble instruction. The scrambled key signal conforms to a different key signal produced by the key matrix. For example, the crossbar may receive a key signal for the “a” key and scramble it to a key signal for the “f” key. The keyboard input processor then receives the “f” key signal when the “a” key is pushed. The KIP would then generate a scan code for “f.” The crossbar prevents the keyboard input processor from knowing what key is actually pushed. Any logging occurring at a compromised keyboard input processor would log the wrong key.

The scramble instruction may be provided by a secure processor. A different scramble instruction may be provided for each keystroke. The scramble instruction may be to open and close a series of switches in the crossbar to cause a first crossbar configuration. The result of the first crossbar configuration is predictable by the secure processor, such that the resulting scan code can be reverse engineered to reveal the actual key pushed. The secure processor may have a table that maps the result of each keystroke in a given crossbar configuration. For example, in a first crossbar configuration an “a” key signal may be converted to an “h” signal, while in a second configuration the “a” signal is converted to a “b” signal. Thus, using the table, a scan code for “h” or “b” could be converted back to “a” given the configuration.

The technology described herein may enable a keyboard to communicate in a standard mode and in a secure mode. In the standard mode, the keyboard communicates like currently available keyboards. Essentially, the crossbar simply passes the key signal without scrambling. The standard mode allows the keyboard to communicate with components that are not capable of receiving secure communications. In the case of an external keyboard, some computing devices may not include a secure processor that is capable of interacting with a crossbar. In this case, the standard mode allows the external keyboard to be used with different devices. With either integrated or external keyboard, some computing devices may operate in secure mode via a secure processor or a standard mode, which does not use the secure processor. The standard mode of the keyboard may be used when the computing device is also in standard mode.

A visual attestation may be displayed on the keyboard's display (e.g., a light or screen). The visual attestation shows that the keyboard 103 is in secure mode and that security policies are actively securing the transfer of data between the keyboard 103 and an in-focus input destination running on the computing device. In some examples, a display on the keyboard, such as a liquid crystal display (LCD) device, provides a textual message on the LCD display as an attestation. Alternatively, the visual attestation on the keyboard 103 could be a lighted key, an LCD light, and/or an icon on the LCD display. In the case of a textual message, the message could identify the container or software application that is the current input destination.

In an aspect, a second attestation could be output through a graphical user interface generated by the input destination (e.g., container). The active status of the secure mode may also be used by the container in different ways. For example, the display of a UI element designed to receive private information (e.g., a password, social security number, birth date, bank account) could be prevented unless the secure mode is active. Instead of preventing display, various warnings could be provided to discourage the user from or warn the user about entering data using an unsecure keyboard.

Referring now to FIG. 2 with FIG. 1, a block diagram is provided showing aspects of an example computing system architecture suitable for implementing some embodiments of the disclosure and designated generally as system 200. FIG. 2 illustrates the secure communication of keystrokes between the keyboard 270, the secure processor 230, the cloud virtual machine 260, and container 216, which is an example input destination.

System 200 depicts an embodiment where the secure processor 230 works with the server 106 to provide a secure environment for the user device 102 and cloud virtual machine 260 to communicate. The secure environment may be bidirectional and end-to-end, starting with the keyboard input and ending with a visual display of the input and/or result of the input. The secure processor 230 may be controlled by an entity providing the cloud virtual machine 260, such that software on the secure processor 230 may only be updated by the entity. This allows the secure processor 230 to certify to the entity that it is providing a secure computing environment. The secure processor 230 may be installed by a computing vendor during manufacturer on behalf of the entity providing the cloud virtual machine 260. The user device 102 may be able to provide other computing environments apart from the secure processor 230. The secure processor 230 and secure video processor 240 may be part of the resources allocated to a container on the user device 102, such as container 216.

In an embodiment, the secure processor 230 may take the form of a system on-chip. The secure processor 230 may include an operating system, processor, memory and other computer functions that are separate from the user device's general hardware 250. However, the secure processor 230 may be connected to a bus that is part of hardware 250 and utilize some of the computing component, such as input output ports, to form a container environment.

In operation, the secure processor 230 may secure the input from the keyboard to the secure processor through the scrambling process described herein. The keyboard input may then be encrypted by the encryption system 234 and communicated through a network connection to the security service 280. The input decryption component 284 of the security service 280 may decrypt the keyboard input and provide it to the cloud virtual machine 260. It should be noted that the keyboard scrambling may be implemented without encryption.

The visual output of the cloud virtual machine may also be secured by the security service 280 and returned the user device 102. The security service 280 may use a video digital rights management component 282 to secure the visual output. The secured visual output may be processed by the secure video processor 240 and output to the user through resources allocated to container 216. It should be noted that the keyboard scrambling may be implemented without secure video processing or DRM management of any image content returned to the user device 102

The system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 provides a detailed view of components of keyboard 270 and the user device 102, including a secure processor 230, a secure video processor 240, a hardware 250, and example containers 210, 212, 214, and 216. Together with components not shown, the operating system components may be described as an operating system. These components may be embodied as a set of compiled computer instructions or functions, program modules, computer software services, or an arrangement of processes carried out on one or more computer systems. The user device 102 may have an operating system and the secure processor 230 may have a separate operating system.

In one embodiment, the functions performed by components of system 200 are associated with securing keystrokes between a keyboard and an input destination, such as a container or application. These components, functions performed by these components, and/or services carried out by these components may be implemented at appropriate abstraction layer(s) such as the operating system layer, application layer, and/or hardware layer of the computing system(s). Alternatively, or in addition, the functionality of these components, and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example system 200, it is contemplated that in some embodiments functionality of these components can be shared or distributed across other components and/or computer systems.

The hardware 250 comprises one or more central processing units (CPUs), memory, and storage 252, and a network interface controller (NIC) 258. The keyboard is shown separate from the hardware to illustrate that external keyboards may be used with the technology described herein. However, internal keyboards, such as found on laptops, may also be used with the technology described herein.

The NIC 258 (also known as a network interface card, network adapter, local area network (LAN) adapter or physical network interface, and by similar terms) is a computer hardware component that connects a computer to a computer network. The NIC allows computers to communicate over a computer network, either by using cables or wirelessly. The NIC may be both a physical layer and data link layer device, as it provides physical access to a networking medium and, for IEEE 802 and similar networks, provides a low-level addressing system through the use of MAC addresses that are uniquely assigned to network interfaces. In aspects, an Internet connection may be used to authenticate the keyboard to the input destination.

Though not shown, the user device 102 may include an input manager that is part of the user device's operating system. The input manager facilitates hardware input. A computer consists of various devices that provide I/O to and from the outside world. Typical devices are keyboards, mice, audio controllers, video controllers, disk drives, networking ports, and so on. Device drivers may provide the software connection between the devices and the operating system. The input manager manages the communication between applications and the interfaces provided by device drivers. The input manager may determine or have access to the control focus of the operating system. The control focus is used to determine an input destination for the keyboard 270. The application or container having the current control focus is the input destination. As control focus changes to different applications, containers, or operating system components, the input destination changes. Control focus may change when a user selects a user interface component associated with an application, container, or operating system component. In an aspect, the input manager may communicate the identity of the input destination to the keyboard 270 and/or the secure processor 230.

The secure processor 230 helps the keyboard function in secure mode and may play a role in standard mode. As mentioned, standard mode enables the keyboard to communicate with non-security enabled input destinations and/or security enabled input destinations that have not activated the security feature. In secure mode, the secure processor 230 may receive a scrambled scan code from the keyboard 270 and convert it to a virtual key, which is communicated as an operating system message by the input manager (or other component) to the input destination. In an aspect, the virtual key is input to a keystroke queue designed to receive and communicate virtual keys to input destinations. In unsecure mode, the unscrambled keystrokes may be communicated to a keyboard driver or other function that convert it to a virtual key.

The session manager 232 manages the communication session between the user device 102 and the server 106. Establishing and/or maintaining the communication session can include providing a security attestation to the security service 280 and/or cloud virtual machine 260. The security attestation can include an indication that key scrambling is active to prevent interception of keystrokes at the KIP.

The encryption system 234 encrypts an unscrambled keystroke and communicates the encrypted keystroke to an input destination. The encryption system 234 can encrypt data using various forms of encryption. CBC-3DES is one type of encryption that may be used. CBC-3DES is a cryptographic function that combines the data encryption standard (DES) with cipher block chaining (CBC). “3DES” means that the DES encryption algorithm is applied to a given block of data three times (“triple-DES”). DES encrypts data by applying a key to the data in a known manner. DES encrypts a long message by dividing the message into smaller blocks, and encrypting the individual blocks. (When “triple-DES” is used, the DES algorithm is applied to each block three times in order to produce the ciphertext for that block.) DES (and triple-DES) can encrypt each block of data using just a key; however, when cipher block chaining is used, the encryption of one block is based not only on the key, but also on the ciphertext that was produced by encrypting the last block. Thus, encryption of a given block is based on two inputs: the key, and the ciphertext that resulted from encrypting the previous block. Since the first block of data to be encrypted has no “previous” block, the cipher block chaining process must be primed with an “initial value”—that is, the first block of data is encrypted based on the key and some initial value. The initial value is not used in the encryption of subsequent blocks, but may indirectly influence how those blocks are encrypted (since the first block's ciphertext is based on the initial value, the second block's ciphertext is based on the first block's ciphertext, and so on). It should be understood that any other block cipher could be used, and chaining concepts similar to CBC could be applied to such a block cipher.

The unscramble control 236 is responsible for generating a scramble instruction and then unscrambling a scrambled keystroke upon receiving it. The scramble instruction acts as a command for the crossbar that results in a particular crossbar configuration. The scramble instruction may be generated in response to an algorithm that takes a seed as input. The algorithm may generate a sequence of scramble instructions that makes unscrambling the keystrokes difficult without knowing the algorithm and the seed. A different scramble instruction may be generated for each key. The scramble instruction may be used to descramble a scrambled key (e.g., scan code).

A crossbar may be able to take a finite number of configurations. For example, a crossbar for a keyboard may be able to take 10, 100, 1000, or more different configurations. Each configuration scrambles the keystroke in a predictable way. The unscramble control 236 may have access to a table or other data store that indicates how each keystroke will be scrambled in a given configuration. For example, for a keyboard with 101 keys, each individual key would be scrambled by the crossbar into a second key in a given configuration. No two keys may be scrambled into the same key. Thus, the letter “a” and “b” would not both be scrambled into the letter “c.” Instead, “a” would be scrambled into a first letter and “b” would be scrambled into a second letter and so on.

The scrambled keystroke may be received by the unscramble control 236 with metadata indicating an order in which the keystrokes were generated. The order of keystroke generation can be used to unscramble the scrambled keystroke. The unscramble control 236 determines the configuration of the crossbar used to generate the scrambled keystroke and then looks at the corresponding table to determine what letter corresponds to the letter provided.

The keyboard 270 includes keys 272, the key matrix 274, the crossbar 276, and the keyboard input processor 278. The keys 272 are mechanical devices that contact the key matrix 274 when pressed. The key matrix 274 generates a unique key signal in response to the key touching a particular portion of the key matrix 274. The key signal generated by the key matrix 274 is communicated to the crossbar 276.

The crossbar takes the configuration according to a scramble instruction. The default configuration for the crossbar may cause no scrambling. In other words, in the default configuration the key signal generated by the key matrix 274 is simply passed along to the KIP 278. The default configuration can cause the keyboard to operate in standard mode. In a non-default configuration specified by the scramble instruction, the crossbar receives the key signal generated by the key matrix 274, which corresponds to a first keystroke and outputs a key signal corresponding to a second keystroke that is different than the first keystroke. The KIP 278 converts the key signal into a scan code or other representation of the keystroke. The scan code is then communicated to the computing device associated with the keyboard.

The keyboard may output a visual attestation when in secure mode (e.g., when scrambling is occurring). The visual attestation may be any type of computer-generated visual output through the keyboard. In one implementation, the visual attestation is a light (e.g., green light) that may be associated with a label, such as “secure mode on.” A second light (e.g., red light) may be associated with a label, such as “secure mode off.” In some configurations, the visual display can be in the form of an LCD. The LCD may be used to provide additional information, such as identification of the input destination. It should be understood that other forms of display may be used, and other computer-generated attestation concepts may be implemented.

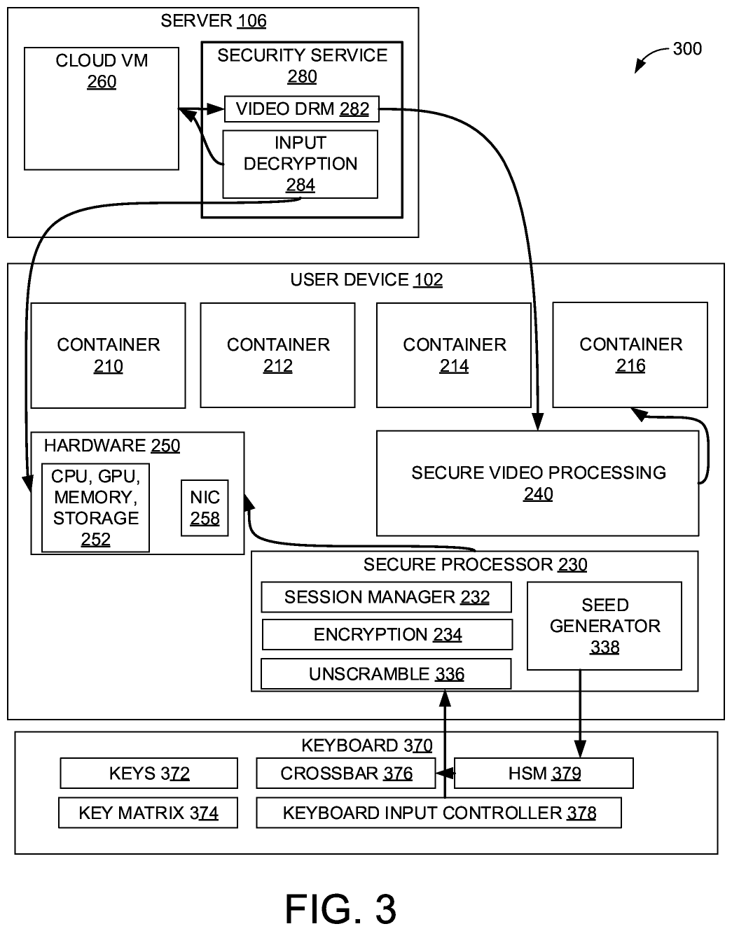

FIG. 3 illustrates an embodiment with an external keyboard 370 that includes a hardware security module 379. The use of HSM 379 causes the addition of a seed generator 338 and also changes the operation of the unscramble control 336. The keys 372 are mechanical devices that contact the key matrix 374 when pressed. The key matrix 374 generates a unique key signal in response to the key touching a particular portion of the key matrix 374. The key signal generated by the key matrix 374 is communicated to the crossbar 376.

The crossbar 376 takes the configuration according to a scramble instruction. The default configuration for the crossbar may cause no scrambling. In other words, in the default configuration the key signal generated by the key matrix 374 is simply passed along to the KIP 378. The default configuration can cause the keyboard to operate in standard mode. In a non-default configuration specified by the scramble instruction, the crossbar receives the key signal generated by the key matrix 374, which corresponds to a first keystroke and outputs a key signal corresponding to a second keystroke that is different than the first keystroke. The KIP 378 converts the key signal into a scan code or other representation of the keystroke. The scan code is then communicated to the computing device associated with the keyboard.

The HSM 379 generates the scramble instruction used by the crossbar 376. The HSM 379 may use a pseudorandom number generator to generate the scramble instruction. The pseudorandom number generator may be limited to generating numbers within a range matching available crossbar configurations. Thus, if the crossbar is capable of 1000 configurations then the pseudorandom number generator may generate number between 1 and 1000.

The seed generator 338 generates a seed for the HSM 379 to use when generating a scramble instruction that the crossbar uses to configure itself. For a seed to be used in a pseudorandom number generator, it does not need to be random. Because of the nature of number generating algorithms, so long as the original seed is ignored, the rest of the values that the algorithm generates will follow probability distribution in a pseudorandom manner. A pseudorandom number generator's number sequence is completely determined by the seed: thus, if a pseudorandom number generator is reinitialized with the same seed, it will produce the same sequence of numbers. The HSM 379 may generate a sequence of scramble instructions from a single seed. The sequence of scramble instructions may be communicated to the crossbar and used in sequence to scramble each consecutive key signal.

### Example Methods

Now referring to FIGS. 4, 5 and 6, each block of methods 400, 500, and 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 400, 500, and 600 are described, by way of example, with respect to FIGS. 1-3. However, these methods may additionally or alternatively be executed by any one system, or any combination of systems, including, but not limited to, those described herein.

FIG. 4 is a flow diagram showing a method 400 of securing communication of data between an input destination on a computing device and a keyboard, in accordance with some embodiments of the present disclosure. Method 400 may be performed on or with systems similar to those described with reference to FIGS. 1-3.

At step 410, the method includes receiving, at a crossbar operating between the keyboard and a keystroke input processor, a scramble instruction. The scramble instruction may be generated by a component of the computing device associated with the keyboard. Example components include the unscramble control of a secure processor, as described previously. In aspects, the unscramble control could be part of the operating system, keyboard driver, or other component.

At step 420, the method includes receiving, at the crossbar, a key signal corresponding to a key on the keyboard. The key signal may be generated by the key matrix in response to the depression of a key on the keyboard.

At step 430, the method includes scrambling, at the crossbar, the key signal according to the scramble instruction to form a scrambled key signal. The crossbar responds to the scramble instruction my transitioning into a first configuration. In the first configuration, each key signal will be converted to a different key signal with a one-to-one correspondence. For example, the “a” signal may be converted to the “f” signal. Each key signal is mapped to a single other key signal and no two key signals are mapped to the same key signal. For example, the “a” signal and “z” signal are not both mapped to the “y” signal.

At step 440, the method includes communicating the scrambled key signal to the keystroke input processor. The keystroke input processor will then generate a scrambled keystroke corresponding to the scrambled key signal received. Thus, a scrambled key signal corresponding to “f” would cause the KIP to generate a scrambled keystroke corresponding to “f.” The scrambled keystroke may be in the form of a scan code.

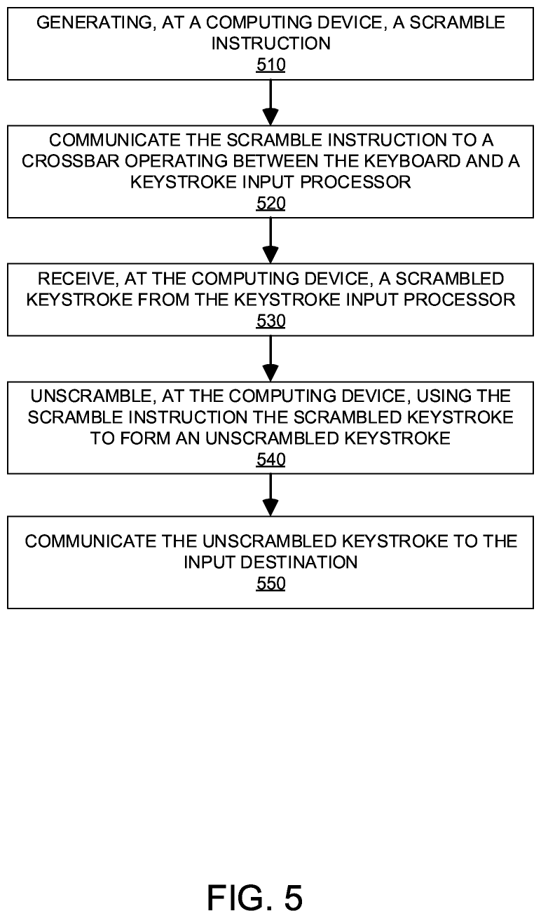

FIG. 5 is a flow diagram showing a method 500 of securing communication of data between an input destination on a computing device and a keyboard, in accordance with some embodiments of the present disclosure. Method 500 may be performed on or with systems similar to those described with reference to FIGS. 1-3.

At step 510, the method includes generating, at a computing device, a scramble instruction. The scramble instruction is directly useable by the crossbar to specify a crossbar configuration. A sequence of scramble instructions may be generated so each keystroke can be scrambled using a different scramble instruction. The

At step 520, the method includes communicating the scramble instruction to a crossbar operating between the keyboard and a keystroke input processor. The cross bar then scrambles a key signal to form a scrambled key signal, as described previously. The scrambled key signal is used by the keystroke input processor to form a scrambled keystroke. At step 530, the method includes receiving, at the computing device, a scrambled keystroke from the keystroke input processor.

At step 540, the method includes unscrambling, at the computing device, using the scramble instruction the scrambled keystroke to form an unscrambled keystroke. As described, the result (e.g., “e” signal instead of “f” signal) of the first crossbar configuration is known by the computing device (e.g., the secure processor), such that the resulting scan code can be reverse engineered (e.g. “f” to “e”) to reveal the actual key pushed. The computing device may have a table that maps the result of each keystroke in a given crossbar configuration to a key push. For example, in a first crossbar configuration an “a” signal may be converted to an “h” signal, while in a second configuration the “a” signal is converted to a “b” signal. Thus, using the table, a scan code for “h” or “b” could be converted back to “a” given the configuration, which may be ascertained from the scramble instruction provided. At step 550, the method includes communicating the unscrambled keystroke to the input destination. The input destination may be a virtual machine, application, container, and the like.

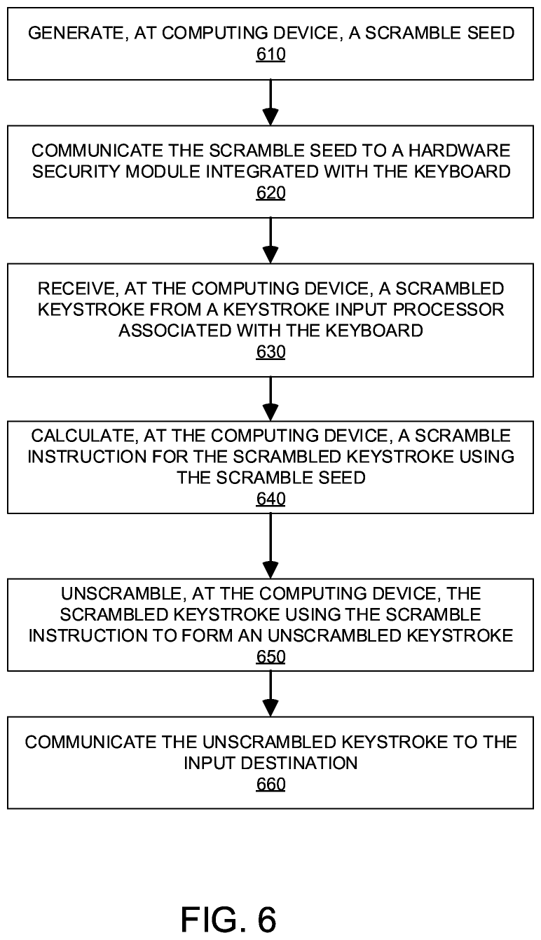

FIG. 6 is a flow diagram showing a method 600 of securing communication of input data between an input destination on a computing device and a keyboard, in accordance with some embodiments of the present disclosure. Method 600 may be performed on or with systems similar to those described with reference to FIGS. 1-3.

At step 610, the method includes generating, at a computing device, a scramble seed. A random number generator may be used to select the seed. At step 620, the method includes communicating the scramble seed to a hardware security module integrated with the keyboard. As described, the HSM will use the seed to generate a scramble instruction, which corresponds to a crossbar configuration. The crossbar then receives a key signal and converts it to a scrambled key signal. The KIP uses the scrambled key signal to generate a scrambled keystroke.

At step 630, the method includes receiving, at the computing device, a scrambled keystroke from a keystroke input processor associated with the keyboard. At step 640, the method includes calculating, at the computing device, a scramble instruction for the scrambled keystroke using the scramble seed. As described, a pseudorandom number generator's number sequence is completely determined by the seed: thus, if a pseudorandom number generator is reinitialized with the same seed, it will produce the same sequence of numbers. In this way, the computing device may calculate the same scramble instructions being generated by the HSM.

At step 650, the method includes unscrambling, at the computing device, the scrambled keystroke using the scramble instruction to form an unscrambled keystroke. At step 660, the method includes communicating the unscrambled keystroke to the input destination.

### Example Operating Environment

Referring to the drawings in general, and initially to FIG. 7 in particular, an example operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of a computing device that may be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.”

Computing device 700 typically includes a variety of computer-readable media. Computer-readable media may be any available media that may be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Example memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Example presentation components 716 include a display device, speaker, printing component, vibrating component, etc. I/O ports 718 allow computing device 700 to be logically coupled to other devices, including I/O components 720, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include a radio 724. The radio 724 transmits and receives radio communications. The computing device may be a wireless terminal adapted to receive communications and media over various wireless networks. Computing device 700 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### EMBODIMENTS

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by a keyboard performs a method of securing communication of keystrokes between a keyboard and an input destination, the method comprising:
receiving, at a crossbar operating between the keyboard and a keystroke input processor, a scramble instruction;
receiving, at the crossbar, a key signal corresponding to a key on the keyboard;
scrambling, at the crossbar, the key signal according to the scramble instruction to form a scrambled key signal; and
communicating the scrambled key signal to the keystroke input processor.

2. The media of claim 1, wherein the scramble instruction is received from a hardware security module operating on the keyboard.

3. The media of claim 2, wherein the method further comprises the hardware security module calculating the scramble instruction from a seed provided by a unscramble control operating on a computing device communicatively coupled to the keyboard.

4. The media of claim 1, wherein the scramble instruction is received from a secure processor operating on the computing device associated with the keyboard.

5. The media of claim 4, wherein the method further comprises the keystroke input processor communicating the scrambled keystroke to the secure processor.

6. The media of claim 1, wherein the method further comprises receiving, at the crossbar, an activation message to initiate a secure mode.

7. The media of claim 1, wherein the method further comprises outputting a visible indication from the keyboard to indicate a secure input mode is active.

8. A method of securing communication of keystroke data between a keyboard and an input destination, the method comprising:
generating, at a computing device, a scramble instruction;
communicating the scramble instruction to a crossbar operating between the keyboard and a keystroke input processor;
receiving, at the computing device, a scrambled keystroke from the keystroke input processor;
unscrambling, at the computing device, using the scramble instruction the scrambled keystroke to form an unscrambled keystroke; and
communicating the unscrambled keystroke to the input destination.

9. The method of claim 8, further comprising encrypting the unscrambled keystroke prior to communicating the unscrambled keystroke to the input destination.

10. The method of claim 8, wherein the input destination is an application in control focus.

11. The method of claim 8, wherein the input destination is a container that uses resources of a host operating system, wherein the host operating system is installed on the computing device.

12. The method of claim 8, wherein the input destination is a virtual machine running in a data center.

13. The method of claim 8, wherein the method further comprises providing a secure mode activation instruction to the crossbar.

14. The method of claim 13, wherein the method comprises providing a sequence of scramble instructions for consecutive keystrokes.

15. A method for implementation of a secure mode for communicating input data between a keyboard and an input destination, comprising:
generating, at a computing device, a scramble seed;
communicating the scramble seed to a hardware security module integrated with the keyboard;
receiving, at the computing device, a scrambled keystroke from a keystroke input processor associated with the keyboard;
calculating, at the computing device, a scramble instruction for the scrambled keystroke using the scramble seed;
unscrambling, at the computing device, the scrambled keystroke using the scramble instruction to form an unscrambled keystroke; and
communicating the unscrambled keystroke to the input destination.

16. The method of claim 15, wherein the hardware security module generates the scramble instruction using the scramble seed and communicates the scramble instruction to a crossbar operating between the keyboard and the keystroke input processor.

17. The method of claim 16, wherein the keyboard is an external keyboard communicatively coupled to the computing device.

18. The method of claim 15, further comprising encrypting the unscrambled keystroke prior to communicating the unscrambled keystroke to the input destination.

19. The method of claim 15, wherein the input destination is a virtual machine running in a data center.

20. The method of claim 15, wherein the method further comprises providing a secure mode activation instruction to the hardware security module.
